(19) United States
(12) Patent Application Publication
(10) Pub. No.: US 2015/0207367 A1
(43) Pub. Date: Jul. 23, 2015

(54) LAMINAR SEGMENT FOR ELECTRIC MOTOR SEGMENTED STATOR

(71) Applicant: WHIRLPOOL S.A., São Paulo-SP (BR)

(72) Inventors: Alberto Bruno Feldmann, Joinville (BR); Aleandro Amauri de Espindola, Joinville (BR); Rodrigo Link, Joinville (BR)

(21) Appl. No.: 14/409,156

(22) PCT Filed: Jun. 18, 2013
(86) PCT No.: PCT/BR2013/000215

§ 371 Date: Dec. 18, 2014

(30) Foreign Application Priority Data
Jun. 29, 2012 (BR) BR1020120162881

(51) Int. Cl. H02K 1/14; H02K 3/02

(52) U.S. Cl. CPC H02K 1/148; H02K 3/02

(57) ABSTRACT

The present invention refers to an electric motor with segmented stator and a fluid compressor provided with an electric motor with segmented stator. Segmented stator (E) of the electric motor is composed of segments (4), wherein each segment (4) is constituted by a plurality of laminar segments (1) comprised of at least an external segment (11) and at least a tooth (13).

### FIELD OF THE INVENTION

The present invention refers to the technology of electric motor and similar equipments.

The present invention generally relates to a laminar segment for electric motor segmented stator and, more particularly, to the geometry and/or format of said laminar segment for electric motor segmented stator.

### BACKGROUND OF THE INVENTION

It is already known by those skilled in the art electric motors which comprise machines capable of converting electric energy to mechanic energy.

Generally speaking, and according to specialized academic publications, electric motors comprise fixed inductive cores and mobile inductive cores, and have their main functional principle based on electromagnetic induction principles, where magnetic fields generated by the fixed inductive cores are capable of generating movement in the mobile inductive cores. In this sense, it is also known by those skilled in the art that the fixed inductive cores are disclosed in the stator while the mobile inductive cores are arranged in the rotor.

From the constructive point of view, an electric motor stator is essentially composed of a metal frame and a plurality of coils (electric conductors disposed in a manner surrounding a shaft), wherein said coils are disposed in alignment with the metal frame.

In this sense, and as known by those skilled in the art, a stator package of an electric motor can be obtained from a metal monoblock from a plurality of metal blades, or also from a plurality of metal blade segments. This latter type of stator is named segmented stator.

The main advantages of a segmented stator over a monoblock stator ou a laminar stator are particularly perceivable when analyzed from an industrial point of view. This mainly occurs due to raw material savings since laminar segments can be obtained from an essentially thin metal blade in stamping processes because blade formats allow for spaces between the segments to be reduced. Furthermore, with regard to the cases where a rotor core is not formed of blades, according to BR Patent Application PI0905651-3, material savings are increased. The second advantage provided by the use of laminar segments refers to improvement in winding process since access to the groove remains totally free, thereby enhancing the accuracy to guide a yarn around each coil winding, thereby making it possible to carry out the concentrate yam winding process and, consequently, to add a higher number of turns and/or higher volume of coil material to one same groove area.

Examples of laminar segments as well as examples of segmented stators are disclosed in EP 1364442, JP 2020141942, U.S. Pat. No. 7,414,347, U.S. Pat. No. 7,471,025, U.S. Pat. No. 7,821,175, and CN

EP 1364442 and U.S. Pat. No. 7,414,347 describe in a simplified form stator segments formed of multiple laminar segments. Each of said laminar segments has a contour analogous to a T-shape wherein a substantially horizontal portion further comprises a side recess and a side protrusion, both oppositely disposed to form self-coupling “male-female” members and specially intended to join the stator segments.

With regard to JP 2010141942 and U.S. Pat. No. 7,471,025 describe examples of geometries of laminar segments. In addition, such documents also teach blade matrices, from which said laminar segments are removed (using stamping processes).

U.S. Pat. No. 7,821,175 and CN 201008100 in turn disclose segmented stators formed by physical association of stator segments. In both documents, it is also common to see that physical association of stator segments provides for the use of external structures, such as, for example, ring-shaped structures.

Although the above-mentioned documents only illustrate examples of embodiments pertaining to the state of the art, it can be clearly noted that most of the currently existing segmented stators include fundamental aspects disclosed in such examples. From this observation the main drawbacks referring to these examples and, consequently, presented in most of currently existing segmented stators are easily verified.

The first drawback refers to a constructive point of view. As disclosed in JP 2010141942 and U.S. Pat. No. 7,471,025, it is observed that the current blade matrices in function of the geometry of the laminar segments generate high amount of metal scrap. This is due to the fact that said geometry of the laminar segments aims at generating higher functional efficiency to the stator and not a smaller amount of scrap.

The second drawback refers to stator assembly and/or arrangement. U.S. Pat. No. 7,821,175 and CN 201008100 teach that the stator assembly requires the use of external structures which add dimensions to said stator.

The present invention has been developed based on this scenario.

### OBJECTS OF THE INVENTION

Hence, an object of the present invention is to provide a laminar segment for electric motor segmented stator having geometry capable of reducing the amount of scrap (raw material optimization) without impairing electric efficiency of said motor. Another object of the present invention is to provide a laminar segment for electric motor segmented stator that has the ability to use aluminum thread in the composition of its coil.

### SUMMARY OF THE INVENTION

These and other objects of the present invention are achieved by means of a laminar segment for electric motor segmented stator, which comprises at least an external segment and at least a perpendicular segment called tooth, in addition to containing two side ends projected from each of the side ends of the external segment (that after joining said segments in the assembly is named crown), and two side ends projected from each of said lower ends of the tooth. Said side ends have right faces substantially parallel therebetween and left faces also substantially parallel therebetween. Preferably, one of said side ends further comprises a coupling projection while the other side end comprises a coupling recess.

In accordance with the principles and objects of the present invention, the right faces have an angular inclination complementary to the angular inclination of the left faces. It should be pointed out that, in accordance with the present invention, said electric motor having a segmented stator comprises electric coils made of aluminum.

### BRIEF DESCRIPTION OF DRAWINGS

The present invention will be described in detail based on the figures listed below, wherein:

FIG. 1 illustrates a second laminar segment for the electric motor segmented stator in accordance with the present invention;

FIG. 2 illustrates laminar segments for the electric motor segmented stator in the blade matrix disposed at the blade matrix in accordance with the present invention; and

FIG. 3 illustrates laminar segments for the segmented stator in the stator package itself.

### DETAILED DESCRIPTION OF THE INVENTION

As previously mentioned, one of the main objects of the present invention is to provide laminar segments (that in conjunction form segments for electric motor segmented stators) which can be obtained/made of an optimized amount of raw material (metal blades and/or sheets).

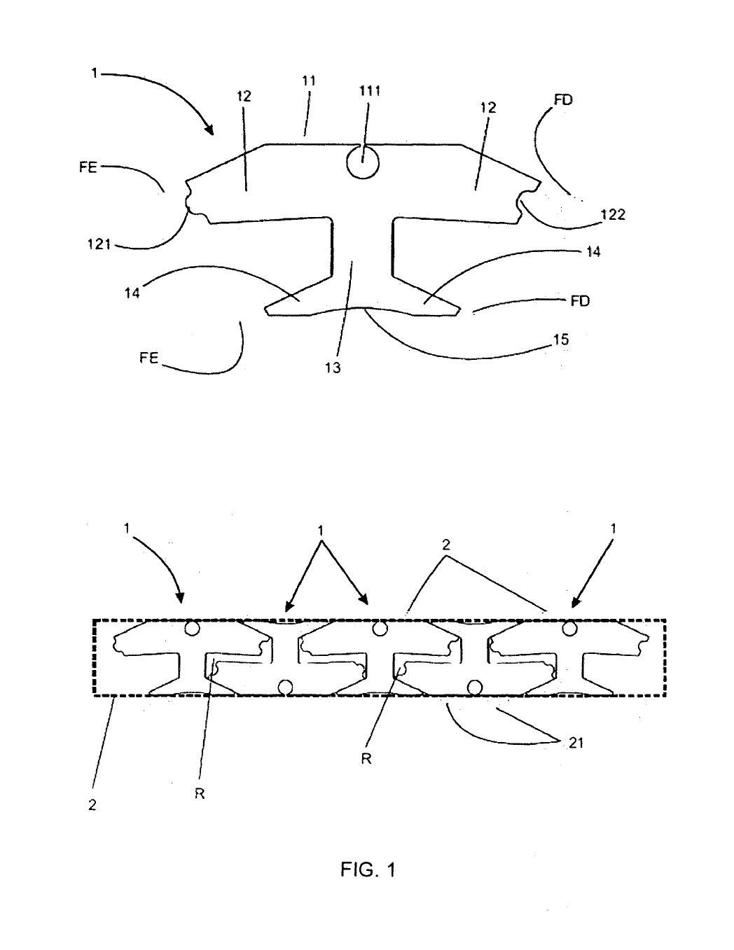

In this sense, and in accordance with the present invention, a laminar segment 1 that is depicted in FIG. 1 in an amplified form is disclosed.

Said laminar segment 1 that has geometry essentially analogous to letter T is essentially constituted by an external segment 11 and a tooth 13, wherein said external segment 11 corresponds to the horizontal portion of the T-shaped geometry; and said tooth 13 corresponds to the vertical portion of said T-shaped geometry. Attention should be drawn to the fact that laminar segments having T-shaped geometry are widely known by those skilled in the art.

Nevertheless, and unlike the laminar segments pertaining to the current state of the art, the presently disclosed laminar segment 1 is shown to have two end sides 12 projected from each of the side ends of the external segment 11 and two side ends 14 projected from each of said lower side ends of tooth 13.

As can be seen from FIG. 1, it is essentially required that said side end 12 and said side end 14 of opposite sides of one same laminar segment 1 have substantially parallel faces therebetween.

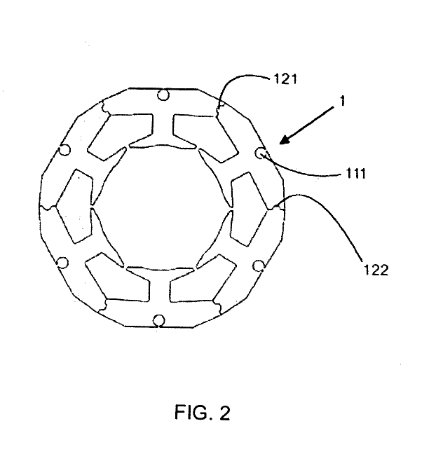

Additionally, as shown in FIG. 2, and according to a second preferred embodiment of the laminar segment 1, an optimized geometry aiming at reducing raw material is obtained when said side ends 12 and side ends 14 have right faces (FD) substantially parallel therebetween, and when said side ends 12 and said side ends 14 comprise right faces (FE) substantially parallel therebetween.

It is then observed that, in accordance with the preferred embodiment of the laminar segment 1, the right faces FD have an angular inclination complementary to the angular inclination of the left faces FE, wherein the reverse is evidently true.

Such geometry permit to define in one same blade matrix 2 multiple laminar segments 1, which segments have their side ends 12 and 14 “resting” against one another. It is then verified that said laminar segments 1 (of one same blade matrix 2) can be “separated” from one another through linear cuts 21 (virtual lines). Generation of raw material scrap R in accordance with the laminar segment 1 is significantly smaller than the generation of scrap relative to laminar segments pertaining to the state of the art.

Preferably, in accordance with a now detailed preferred embodiment, the multiple laminar segments 1 are defined in one same blade matrix 2, and “separated” from each other by means of conventional stamping processes, which are usually carried out in presses.

Further, as illustrated in FIG. 1, it is observed that preferably each lamina segment 1 additionally comprises a circular face 15 that is defined at the lower end of its tooth 13. However, and in a further preferred form, it is further verified that the external segment 11 of the laminar segment 1 has also a centrally disposed through-hole 111.

Moreover, in an optional form, it should be cited that one of said side ends 12 (according to the attached figures, left side end 12) also comprises a coupling projection 121 whereas the other side end 12 (according to the attached figures, left right side end 12) also comprises a coupling recess 122. Coupling projections 121 and coupling recesses 122 assist segments 4 to be joined, as depicted in FIG. 3.

Each segment 4 is composed of a plurality of laminar segments 1, all of them vertically aligned (or disposed) with one another.

Still in accordance with FIG. 3, it can be noted that said segments 4 in accordance with the present invention can be joined to one another to thereby define the structural portion of stator E.

One of the advantages presented by using segmented stators refers to the possibility of winding metal conductors 5 (electric coil) around multiple teeth 13 of the (duly joined) multiple laminar segments 1 before the final mounting of the stator E itself.

It should be pointed out that in accordance with the present invention segments 4 of the presently disclosed stator E preferably use metal conductors 5 made of aluminum.

Having described the preferred embodiment of the present invention, it should be understood that the scope thereof contemplates other possible variations, which are only limited by the contents of the appended claims, including possible equivalent means.

1. Laminar segment for electric motor segmented stator, comprising at least an external segment and at least a tooth, said laminar segment comprising:
two side ends projected from the external segment;
two side ends projected from a perpendicular segment of the tooth;
the side ends and side ends comprise right faces (FD) substantially parallel therebetween; and
the side ends and side ends comprise left faces (FE) substantially parallel therebetween; said laminar segment characterized in that;
the right face (FD) and the left face (FE) of side ends comprise rectilinear chamfers defined in an opposite angular direction therebetween and disposed between the superior extension of the external segment and fitting borders; and
the right face (FD) and the left face (FE) of side ends projecting from said perpendicular segment of the tooth and comprising rectilinear chamfers defined in an opposite angular direction therebetween, wherein said perpendicular segment of the tooth projects perpendicularly from a inner central portion of the external segment.

2. Laminar segment, in accordance with claim 1, characterized in that the right face (FD) comprise chamfer angular inclination supplementary to the chamfer angular inclination of the respective right face (FD) of side ends; and
the left face (FE) of side ends comprise a chamfer angular inclination supplementary to the chamfer angular inclination of the respective left face (FE) of side ends.

3. Laminar segment, in accordance with claim 1, characterized in that each laminar segment comprises a circular face disposed between the side ends (14).

4. Laminar segment, in accordance with claim 1, characterized in that said external segment further comprises a through-hole.

5. Laminar segment, in accordance with claim 1, characterized in that one of said side ends further comprises a coupling projection on its fitting border.

6. Laminar segment, in accordance with claim 1, characterized in that one of said side ends further comprises a coupling recess on its fitting border.

7. Laminar segment, in accordance with claim 1, characterized in that it comprises electric coils made of aluminum
